(19) United States
(12) Patent Application Publication
(10) Pub. No.: US 2013/0318982 A1
(43) Pub. Date: Dec. 5, 2013

(54) TURBINE COOLING APPARATUS

(71) Applicant: Yong Weon Kim, San Diego, CA (US)

(72) Inventor: Yong Weon Kim, San Diego, CA (US)

(73) Assignee: Solar Turbines Incorporated

(21) Appl. No.: 13/483,613

(22) Filed: May 30, 2012

(51) Int. Cl. F02C 7/12; F01D 5/20; F01D 5/18; F02C 3/04

(52) U.S. Cl. 60/772; 416/97 R; 60/805

(57) ABSTRACT

The present disclosure describes a turbine blade for a turbine section of a gas turbine engine. The turbine blade includes an airfoil, a platform extending from one side of the airfoil, a root extending from the platform, and at least one purging fin. The at least one purging fin is connected to the root and an underside of the platform, and the at least one purging fin extends along a wall of the root.

### TECHNICAL FIELD

The present disclosure relates generally to gas turbine engine (GTE) cooling, and more particularly to the reduction of hot gas ingress into turbine rotor cavities of GTEs.

### BACKGROUND

GTEs produce power by extracting energy from a flow of hot gas produced by combustion of fuel in a stream of compressed air. In general, turbine engines have an upstream air compressor coupled to a downstream turbine with a combustion chamber (“combustor”) in between. Energy is released when a mixture of compressed air and fuel is burned in the combustor. In a typical turbine engine, one or more fuel injectors direct a liquid or gaseous hydrocarbon fuel into the combustor for combustion. The resulting hot gases are directed over blades of the turbine to spin the turbine and produce mechanical power.

GTEs can be operated at temperatures higher than the physical property limits of the materials from which the engine components may be constructed. The hot gases directed over the blades of the turbine may ingress into turbine rotor cavities in the turbine section due to pressure variations created as the turbine rotor rotates past the stator. Therefore, GTEs are typically provided with an internal air delivery system whereby a flow of cooling air is circulated within the engine to limit the operating temperatures of the engine components through the use of cooling air. Cooling air passages, internal to the engine, are typically used to direct the flow of such cooling air to the necessary engine components, thereby reducing the engine component temperature to a level that is consistent with the material properties of a particular component. Conventionally, a portion of compressed air, bled from the compressor section, is used to cool hot components of a GTE. The amount of bleed air, however, is usually limited so that a main portion of the compressed air is reserved for engine combustion and providing useful engine power.

U.S. Pat. No. 7,967,559 to Bunker (“the '559 patent) describes a turbomachine where the flow of hot gas through regions of stator-rotor assemblies is impeded. Specifically, coolant air is bled from a compressor and directed from an inboard region of the engine into a cavity or wheel-space region to counteract the hot gas flow. In addition to the coolant air, the turbomachine of the '559 patent includes a pattern of inverted turbulators. As hot gas moves from the combustor across the inverted turbulators, they impede the flow of hot gas by generating local flow vortices, thereby restricting the flow of hot gas into the wheel-space region.

### SUMMARY

In one aspect, a turbine blade for a turbine section of a gas turbine engine is disclosed. The turbine blade includes an airfoil, a platform extending from one side of the airfoil, a root extending from the platform, and at least one purging fin. The at least one purging fin is connected to the root and an underside of the platform, and the at least one purging fin extends along a wall of the root.

In another aspect, a gas turbine engine is disclosed. The gas turbine engine includes a compressor section configured to compress a flow of air, a combustor section configured to combust a mixture of the air and a fuel to produce a hot gas flow, and a turbine section configured to use the hot gas flow to produce power. The turbine section includes at least one stator, at least one rotor, and a turbine rotor cavity disposed between the at least one stator and the at least one rotor. A plurality of stator vanes are connected to the at least one stator, and a plurality of turbine blades are connected to the at least one rotor. Each turbine blade of the plurality of turbine blades includes an airfoil, a platform extending from one side of the airfoil, a root extending from the platform, and at least one purging fin. The at least one purging fin is connected to the root and an underside of the platform, and the at least one purging fin extends along a wall of the root.

In yet another aspect, a method of cooling components of a gas turbine engine is described. The method includes generating a pumping action in a turbine section of the gas turbine engine, wherein the pumping action produces an outflow that opposes ingress of combustion gases into a turbine rotor cavity of the turbine section.

### BRIEF DESCRIPTION OF THE DRAWINGS

FIG. 1 is a sectional view of a portion of a GTE;

FIG. 2 is an enlarged sectional view of the encircled portion 2 of the turbine section of the GTE of FIG. 1;

FIG. 3 is a first perspective view of a turbine blade of the GTE of FIG. 1;

FIG. 4 is second perspective view of a turbine blade of the GTE of FIG. 1;

FIG. 5 is a third perspective view of the turbine blade of the GTE of FIG. 1;

FIG. 6 is a fourth perspective view of the turbine blade of the GTE of FIG. 1;

FIG. 7 is a first perspective view of a stator vane of the GTE of FIG. 1;

FIG. 8 is a second perspective view of the stator vane of the GTE of FIG. 1; and

FIG. 9 is a schematic view of a portion of the first stage of the turbine section of the GTE of FIG. 1.

### DETAILED DESCRIPTION

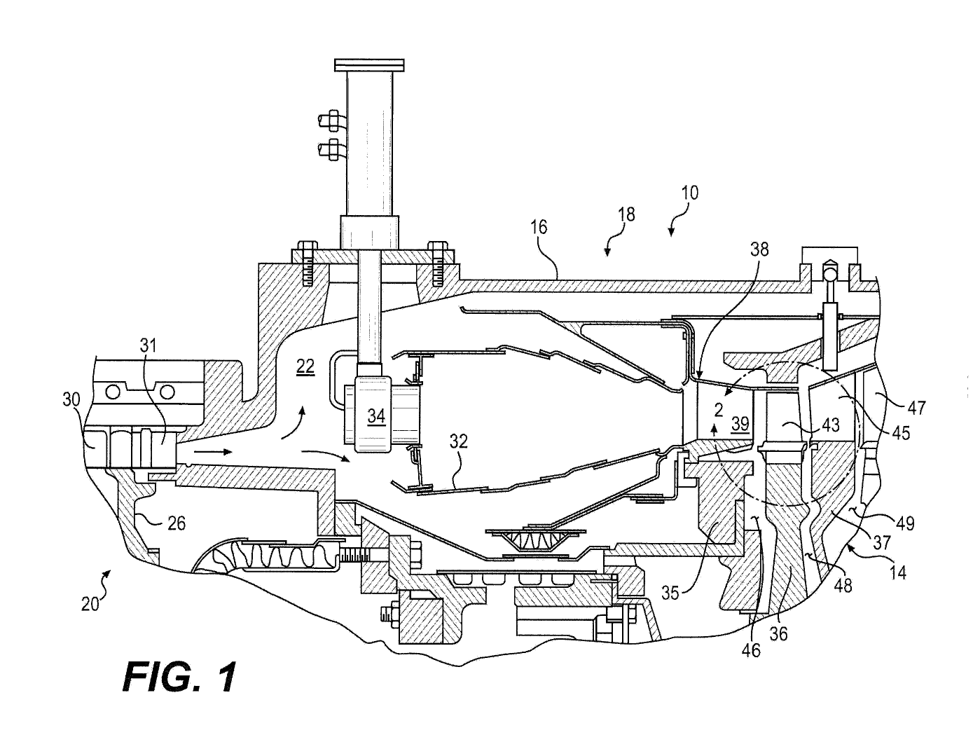

FIG. 1 illustrates a sectional view of a portion of a GTE 10. The GTE includes an outer case 16, a compressor section 20, a combustor section 18, and a compressor discharge plenum 22 fluidly connecting the compressor section 20 to the combustor section 18. The compressor section 20 with compressor rotor 26 includes a plurality of rotatable compressor blades 30 attached to a longitudinally extending center drive shaft (not shown). A plurality of compressor stator vanes 31 extend radially inward from the outer case 16 and are positioned axially between the rows of rotatable compressor blades 30. Although the compressor section 20 is typically a multistage axial flow compressor, only one stage (i.e., the final stage) is shown in FIG. 1 for simplicity.

The combustor section 18 may include an annular combustion chamber 32 located within the plenum 22. The combustion chamber 32 is typically supported within the plenum by a supporting structure. A plurality of fuel injection nozzles 34 are also positioned within the plenum 22 at the front, or upstream, end of the combustion chamber 32 as illustrated in FIG. 1. It should also be recognized that a plurality of annular can combustors (not shown) circumferentially spaced within the plenum 22 about the center shaft, could also be used.

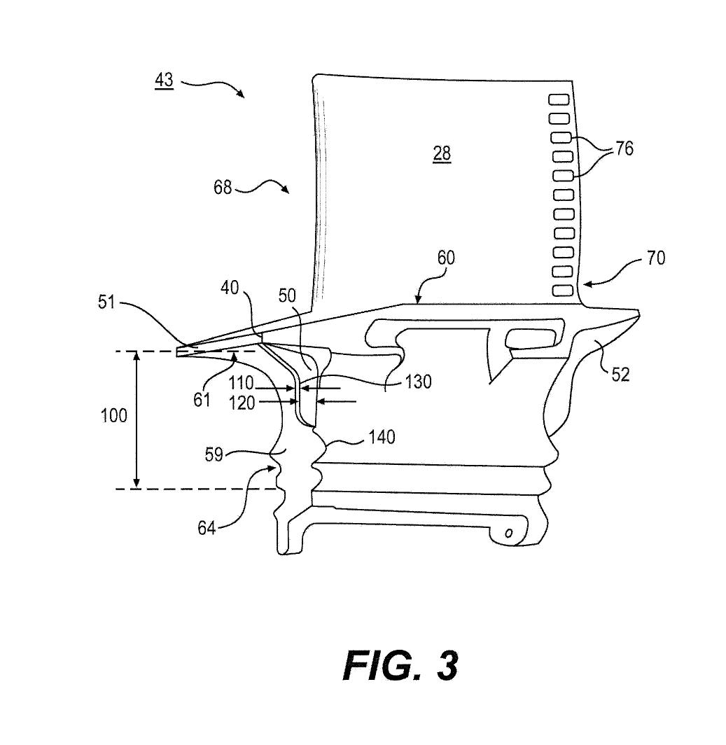

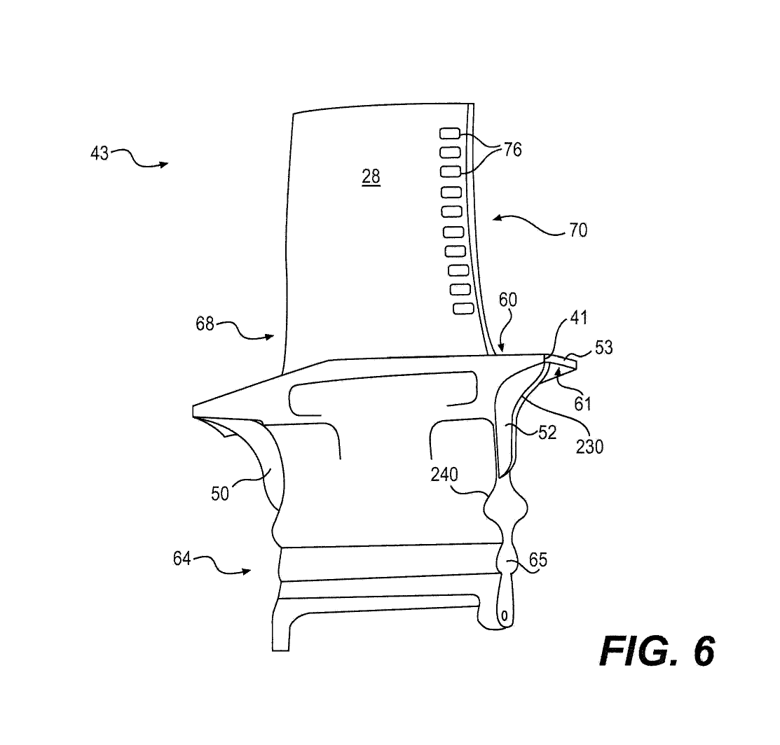

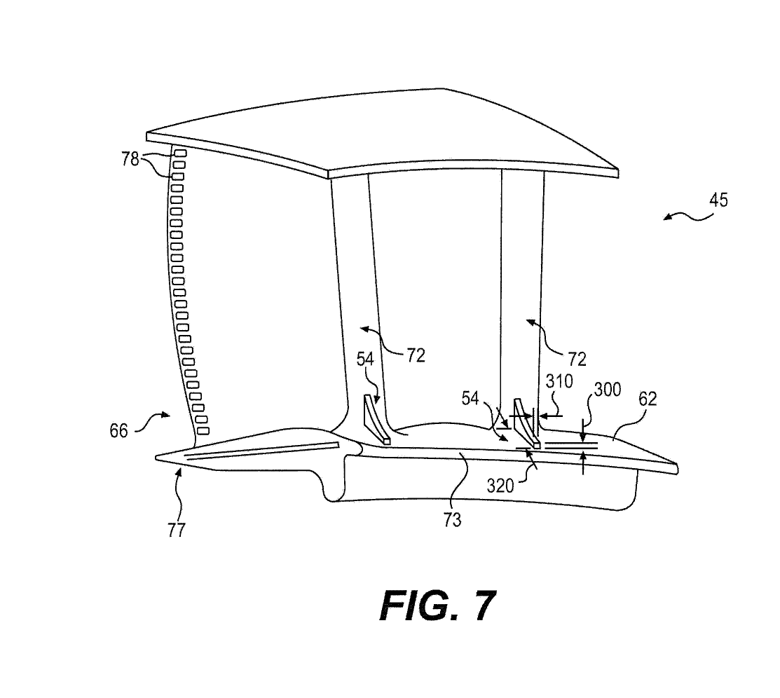

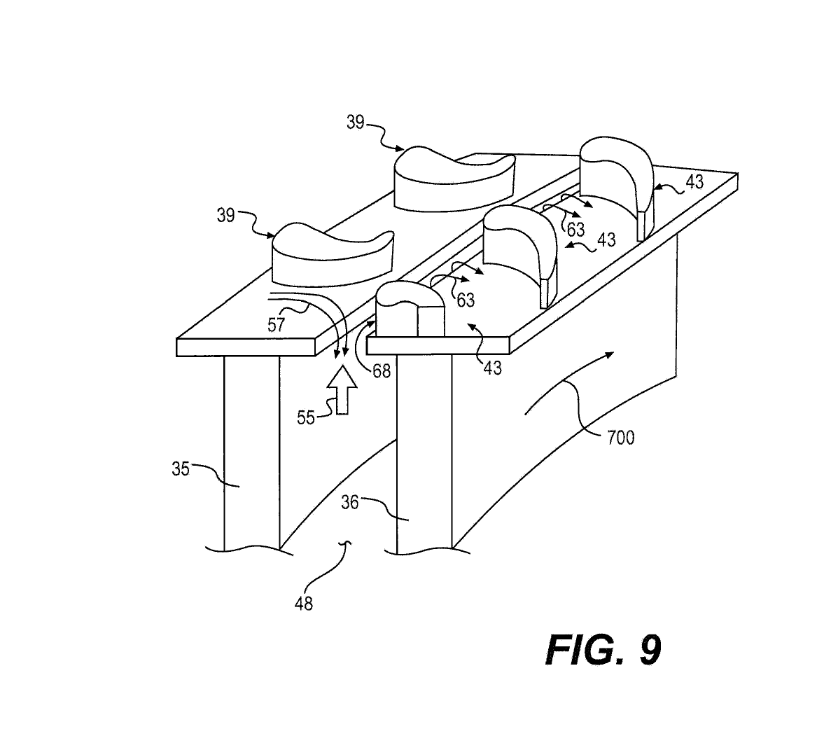

Turbine section 14 includes a shroud 38, and a stator 35 having a plurality of radially extending stator vanes 39 in the first stage of the turbine section 14. The turbine section 14 also includes a rotor 36 that can rotate in a direction 700 (FIG. 9) having a plurality of radially extending turbine blades 43 in the first stage of the turbine section 14. The turbine blades 43 can include a plurality of apertures 76 at a trailing edge 70 (FIGS. 3 and 6). As further shown in FIG. 1, the turbine section includes a stator 37 having a plurality of radially extending stator vanes 45, and a plurality of radially extending turbine blades 47 in a second stage of the turbine section 14. The stator vanes 39, 45 may also be referred to herein as “nozzles,” which are configured to guide a flow of hot combustor gas through the turbine section 14. The stator vanes 39, 45 can include a plurality of apertures 78 at a trailing edge 66 (FIG. 7). Although FIG. 1 only shows the first and second stages of the turbine section 14, with only the first stage being shown in its entirety, the turbine section 14 can include any number of stages. In between the rotor and stator of a given turbine stage there are spaces or plenums, referred to herein as turbine rotor cavities. For example, between the first stage stator 35 and the first stage rotor 36 is a first turbine rotor cavity 46, between the first stage rotor 36 and the second stage stator 37 is a second turbine rotor cavity 48, and between the second stage stator 37 and the second stage rotor 47 is a third turbine rotor cavity 49.

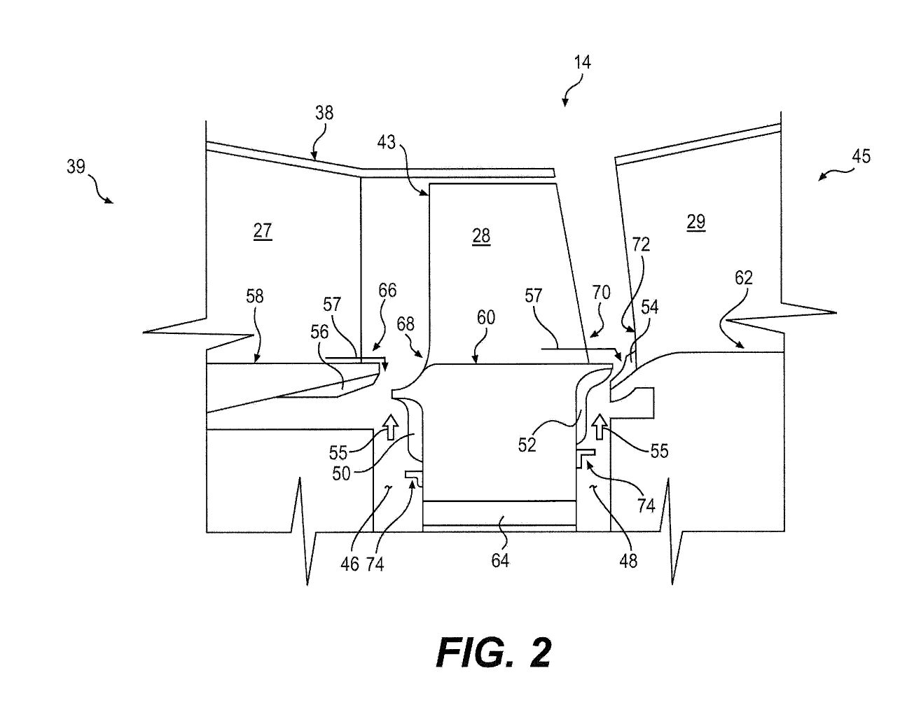

FIG. 2 shows an enlarged sectional view of the encircled portion 2 of the turbine section of the GTE of FIG. 1. As shown in FIG. 2, stator vanes 39 and 45 include stator vane airfoils 27 and 29 and stator vane platforms 58 and 62, respectively. FIG. 2 shows a portion of the stator vane 39 including the trailing edge 66, and a portion of the stator vane 45 including the leading edge 72. The turbine blades 43 each include a turbine blade airfoil 28 and a turbine blade platform 60, a leading edge 68, and a trailing edge 70. The turbine blades 43 also include a root 64 for securing the turbine blades 43 to the rotor 36.

In order to oppose hot combustion gas from flowing into the turbine rotor cavities 46, 48, the turbine blade 43 may optionally include one or more discouragers 74. As shown in FIG. 2, the discouragers 74 project from the root 64 of the turbine blade 43 into the turbine rotor cavities 46, 48.

As illustrated in FIG. 2, the turbine blade 43 includes two purging fins 50, 52 disposed in the first and second turbine rotor cavities 46, 48, respectively. Purging fin 50 may be referred to as a first purging fin, and purging fin 52 may be referred to as a second purging fin. The purging fin 50 is located proximate the leading edge 68 of the turbine blade 43, and the purging fin 52 is located proximate the trailing edge 70 of the turbine blade 43. As shown in more detail in FIGS. 3-6, the purging fins 50, 52 can extend from an underside of the turbine blade platform 60 along the root 64.

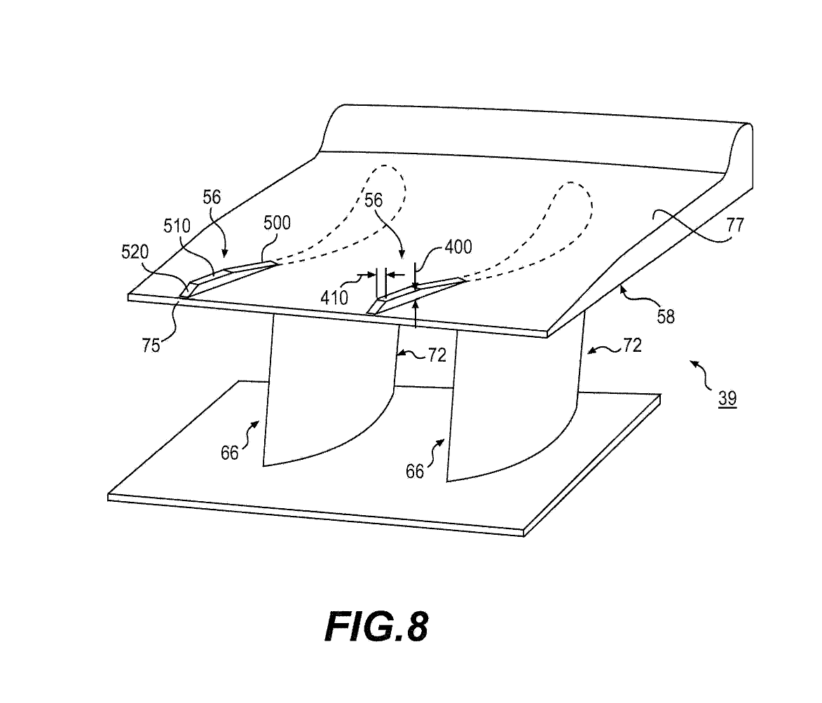

FIG. 2 also shows the stator vane 39 having a guide fin 56 at the trailing edge 66 on an underside of the platform 58 of the stator vane 39. The stator vane 45 includes a guide fin 54 at the leading edge 72 on an upper-side of the platform 62 of the stator vane 45. The guide fin 54 may be referred to as a first guide fin, and the guide fin 56 may be referred to as a second guide fin. Although only a portion of the stator vanes 39 and 45 are shown in FIG. 2, each stator vane can include guide fins at the leading edge and trailing edge of the stator vane, as described in more detail below with respect to FIGS. 7 and 8.

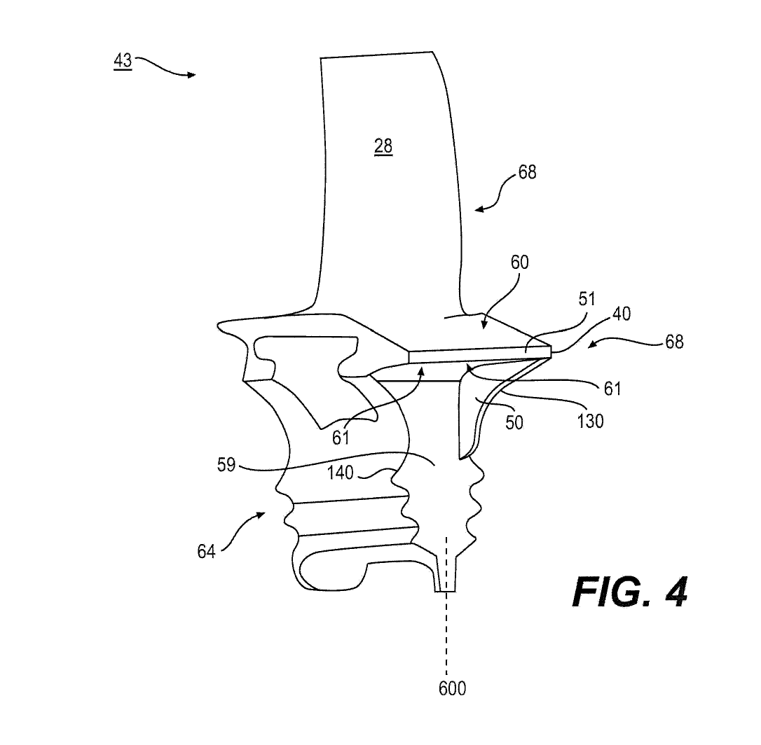

FIGS. 3-6 show various perspective views of the turbine blade 43 of FIG. 1. As noted above, the turbine blade 43 can include two purging fins, 50 and 52. FIGS. 3 and 4 illustrate perspective views showing the purging fin 50 proximate the leading edge 68 of the turbine blade 43. The purging fin 50 extends along a forward wall 59 of the root 64 from an underside 61 of the platform 60. As shown in FIGS. 3 and 4, the portion of the forward wall 59 along which the purging fin 50 extends can be substantially flat. In some instances, the purging fin 50 can extend axially to a forward edge 51 of the turbine blade platform 60; however, in other instances, the purging fin 50 may stop before reaching the forward edge 51. The forward edge 51 may also be referred to as an “upstream edge.” As shown in FIGS. 3 and 4, the purging fin 50 can extend towards a corner 40 of the forward edge 51 of the turbine blade platform 60. The purging fin 50 may also be positioned on one side of a centerline 600 of the turbine blade 43, such that there is space between the centerline 600 and the purging fin 50. If the purging fin 50 is positioned in this manner, the purging fin 50 may be referred to as being “biased” to one side of the turbine blade 43. In other embodiments, the purging fin 50 may be positioned along the centerline 600.

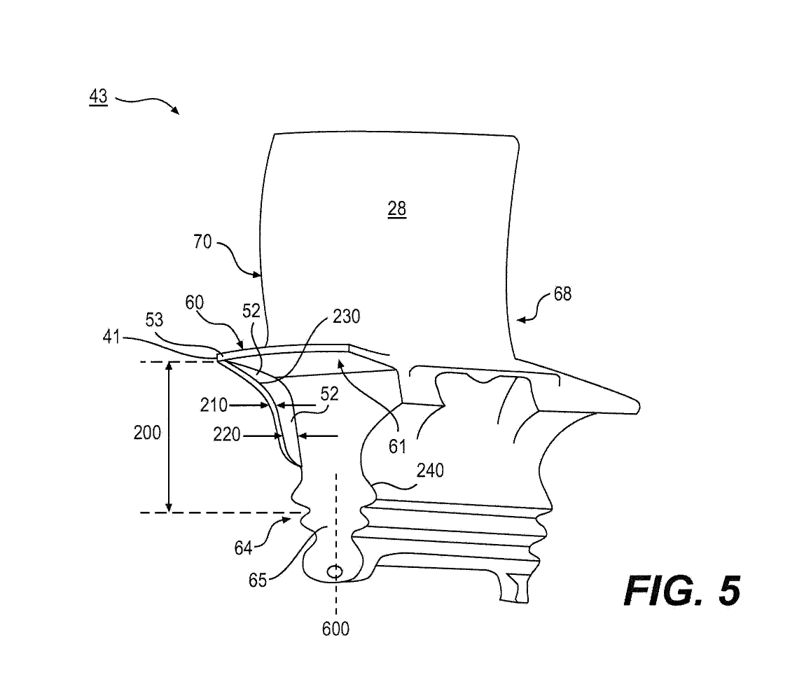

FIGS. 5 and 6 illustrate perspective views showing the purging fin 52 proximate the trailing edge 70 of the turbine blade 43. The purging fin 52 extends along a aft wall 65 of the root 64 from an underside 61 of the platform 60. As shown in FIGS. 5 and 6, the portion of the aft wall 65 along which the purging fin 52 extends can be substantially flat. In some instances, the purging fin 52 can extend to a aft edge 53 of the turbine blade platform 60; however, in other instances, the purging fin 52 may stop before reaching the aft edge 53. The aft edge 53 may also be referred to as a “downstream edge.” As shown in FIGS. 5 and 6, the purging fin 52 can extend towards a corner 41 of the aft edge 53 of the turbine blade platform 60. Similar to the purging fin 50, the purging fin 52 may also be biased to one side of the centerline 600 of the turbine blade 43, such that there is a space between the centerline 600 and the purging fin 52. In other embodiments, the purging fin 52 may be positioned along the centerline 600. In some instances only one of the purging fins 50 or 52 is biased to one side of the centerline 600, while in other instances both of the purging fins 50 and 52 are biased to one side of the centerline 600. Where both of the purging fins 50, 52 are biased in this manner, they can be positioned on the same side of the centerline 600, as shown in FIGS. 3-6, or they may be positioned on opposite sides of the centerline 600.

As shown in FIG. 3, the purging fin 50 may include a length 100 extending from the underside 61 of the platform 60 to an end of the purging fin 50 on the root 64. The purging fin 50 can also include a thickness 110, and a width 120, which is an outward distance that the purging fin extends from the turbine blade 43. Similarly, as shown in FIG. 5, the purging fin 52 can include a length 200 extending from an underside 61 of the platform 60 to an end of the purging fin 52 on the root 64. The purging fin 52 may also include a thickness 210 and a width 220. As used herein, the term “width” may also be referred to as a “axial width” or a “protruding distance,” as the width indicates the distance by which a vane protrudes into a given turbine rotor cavity, as shown in FIG. 2.

The shape and dimensions of the purging fins 50 and 52 can be determined by the shape of the turbine blade 43. For example, the profiles 130, 230 of the purging fins 50, 52, respectively, can be said to contour to the shape of the blade 43. That is, the purging fins 50, 52 can have profiles 130, 230, respectively, that are similar in shape to the underside 61 of the platform 60 and the root 64. As shown in FIGS. 3 and 4, the profile 130 of the purging fin 50 is contoured to the underside 61 of the platform 60, and to the substantially flat forward wall 59 of the root 64. Similarly, as shown in FIGS. 5 and 6, the profile 230 of the purging fin 52 is contoured to the underside 61 of the platform 60, and to the substantially flat aft wall 65 of the root 64. In other instances (not illustrated), the purging fin 50 may be shaped to follow the curvature 140 of the forward wall 59 of the root 64, and/or the purging fin 52 may be shaped to follow the curvature 240 of the aft wall 65 of the root 64.

The purging fin 50 can also conform to the leading edge 68 of the turbine blade 43, and the purging fin 52 can conform to the trailing edge 70 of the turbine blade 43. As shown in FIGS. 3-6, particularly in FIGS. 3 and 6, the purging fin 50 can be angled so as to extend in the same direction (i.e. at the same angle) as the leading edge 68 of the turbine blade airfoil 28, and the purging fin 52 can be angled so as to extend in the same direction (i.e. at the same angle) as the trailing edge 70 of the turbine blade airfoil 28. In this manner, the purging fins 50, 52 can extend at an angle that is not perpendicular to the forward wall 59 and the aft wall 65, respectively. In other instances, for example where the leading edge 68 and the trailing edge 70 of the airfoil 28 are at an angle perpendicular to the forward wall 59 and the aft wall 65, respectively, the purging fins 50, 52 can extend perpendicularly to the forward wall 59 and the aft wall 65 so as to be aligned with the leading edge 68 and the trailing edge 70, respectively. In this respect, the purging fin 50 can be referred to as being aligned with the leading edge 68, and the purging fin 52 can be referred to as being aligned with the trailing edge 70. Because the shape of the purging fins 50, 52 depends on the shape of a given turbine blade, the purging fins 50, 52 may be referred to as being “blade-shape dependent.”

Further regarding the shape and dimensions of the purging fins 50, 52, as shown in FIGS. 3-6, the width 120, 220 along the length 100, 200 of the purging fins 50, 52, respectively, may vary. For example, as shown in FIG. 3, the width 120 of the purging fin 50 may taper as the purging fin 50 approaches the forward edge 51 of the turbine blade platform 60. The width 120 of the purging fin 50 may also taper as the purging fin 50 approaches the bottom of the root 64. Similarly, as shown in FIG. 4, the width 220 of the purging fin 52 may taper as the purging fin 52 approaches the aft edge 53 of the turbine blade platform 60. The width 220 of the purging fin 52 may also taper as the purging fin 52 approaches the bottom of the root 64.

Although the shape and dimensions of the purging fins 50, 52 are dependent on the shape of the turbine blade, as an example, the purging fins 50, 52 may each have a length 100, 200 of about 12.7 mm (about 0.5 inches), a thickness 110, 210 of about 1.27 mm (about 0.05 inches), and a maximum width 120, 220 of less than about 5.08 mm (about 0.2 inches). These distances, however, are only provided to show examples of possible dimensions of the purging fins 50, 52. The length, thickness, and maximum width of each purging fin 50, 52 can be greater or less than the aforementioned values, depending on the shape of the turbine blade on which the purging fins 50, 52 are provided.

The purging fins 50, 52 are not necessarily identical in shape. The purging fin 50 may include dimensions and/or curvatures that are different from dimensions and/or curvatures of the purging fin 52. For example, one or more, of the length 100, thickness 110, width 120, and profile 130 of the purging fin 50 may differ from the length 200, thickness 210, width 220, and profile 230 of the purging fin 52. Furthermore, although the purging fins 50, 52 are shown via separate outlines in FIGS. 3-6, this is to illustrate exemplary shapes of the purging fins 50, 52. As described in more detail below, the purging fins 50, 52 can be formed integrally with the turbine blade 43, for example, via a casting process.

FIGS. 7 and 8 show stator vanes 45 and 39, respectively, of the GTE 10 illustrated in FIG. 1. Each stator vane 45 and 39 may be referred to as “a pair of stator vanes” because, as shown, FIGS. 7 and 8 each include two stator vane airfoils. FIG. 7 is a perspective view of a pair of stator vanes 45 of the GTE 10. As shown in FIG. 7, the stator vanes 45 can include guide fins 54 positioned at the leading edge 72. The guide fins 54 can extend along the stator vane platform 62 at an angle. For example, the guide fins 54 may extend from a forward edge 73 (also referred to as an “upstream edge”) of the stator vane platform 62 at an angle in the same direction as the leading edge 72 of the stator vanes 45, as shown in FIG. 7. In this respect, the guide fins 54 can be referred to as being aligned with the leading edge 72. Additionally, the guide fins 54 for a given pair of stator vanes, for example, the stator vanes 45 shown in FIG. 7, may extend parallel to one another. In some instances, the guide fins 54 extend to the forward edge 73 of the stator vane platform 62. In other cases, however, one or more of the guide fins 54 may stop before reaching the forward edge 73, or, alternatively, one or more of the guide fins 54 may extend beyond the forward edge 73. As shown in FIG. 7, at least part of the guide fins 54 may taper from the leading edge 72 of the stator vane 45 towards the forward edge 73 of the stator vane platform 62.

FIG. 8 is a perspective view of the stator vanes 39 of the GTE 10 shown in FIG. 1, specifically showing a view of the stator vanes 39 from an underside 77 of the stator vane platform 58 to show the guide fins 56. As shown in FIG. 8, the stator vanes 39 can include the guide fins 56 positioned at the trailing edge 66. The guide fins 56 can extend along an underside 77 of the stator vane platform 58 at an angle. For example, the guide fins 56 may extend at an angle in the same direction as the trailing edge 66 of the stator vanes 39 as shown in FIG. 8. In this respect, the guide fins 56 can be referred to as being aligned with the trailing edge 66. Additionally, the guide fin 56 for a given pair of stator vanes, for example, the stator vanes 39 shown in FIG. 8, may extend parallel to one another. In some instances, the guide fins 56 extend to a aft edge 75 (also referred to as a “downstream edge”) of the stator vane platform 58. In other cases, however, one or more of the guide fins 56 may stop before reaching the aft edge 75, or, alternatively, one or more of the guide fins 56 may extend beyond the aft edge 75. As shown in FIG. 8, the guide fins 56 may taper towards the aft edge 75 of the stator vane platform 58 and also towards the trailing edge 66 of the stator vanes 39.

Like the purging fins 50, 52 of the turbine blades 43, the shape and dimensions of the guide fins 54, 56 of the stator vanes 45, 39, respectively, may be determined based on the shape of the stator vanes 45, 39. As shown in FIGS. 7 and 8, the guide fins 54, 56 can each exhibit a shape that may be described as being trapezoidal or trapezoid-like. The guide fins 56 of FIG. 8, for example, can include a first segment 500, a second segment 510, and a third segment 520 that define the shape of the guide fins 56 as being trapezoidal-like. As shown in FIG. 8, the segments 500, 510, 520 can vary in shape and dimensions. In other instances, however, segments, for example segments 500 and 520, can exhibit the same shape and dimensions, where segment 500 tapers towards the trailing edge 66, and where segment 520 tapers towards the aft edge 75. In other embodiments, however, the guide fins 54, 56 may exhibit any other shape, for example, a more linear shape, rather than a trapezoid-like shape.

The guide fins 54 of FIG. 7 include a width 300, a thickness 310, and a length 320. Similarly, the guide fins 56 of FIG. 8 include a width 400, a thickness 410, and a length 420. Although the shape and dimensions of the guide fins 54, 56 can be dependent on the shape of the turbine blade, as an example, the guide fins 54, 56 may each have a maximum width 300, 400 of about 2.54 mm (about 0.1 inches), and a thickness 310, 410 of about 2.54 mm (about 0.1 inches). As shown in FIGS. 7 and 8, however, the widths 300, 400 can vary along the lengths 320, 420 of the guide fins 54, 56 respectively. The lengths 320, 420 can be determined based on the distance between the leading edge or the trailing edge of a given stator vane, and the forward edge or the aft edge of the stator vane platform, respectively. For example, as shown in FIG. 7, the guide fins 54 have lengths 320 equal to the distance between the leading edge 72 and the forward edge 73 of the stator vane platform 62. The guide fins 56 of FIG. 8 have lengths equal to the distance between the trailing edge 66 and the aft edge 75 of the stator vane platform 58. In some instances, the length 320 of the guide fins 54 can be about 12.7 mm (about 0.5 inches), and the length 420 of the guide fins 56 can be about 25.4 mm (about 1.0 inches). These distances, however, are only provided to show examples of possible dimensions of the guide fin 54, 56. The maximum width, thickness, and length of each guide fin 54, 56 can be greater or less than the aforementioned values, depending on the shape of the stator vane on which the guide fins 54, 56 are provided.

Although guide fins 54 are described with respect to stator vanes 45, and guide fins 56 are described with respect to stator vanes 39, a given stator vane of a GTE according to the present disclosure can include both guide fins 54 and 56. For example, although FIG. 7 shows a stator vane 45 having guide fins 54, and FIG. 8 shows a stator vane 39 having guide fins 56, one or both of the stator vanes 45 and 39 can include both guide fins 54 and 56.

### INDUSTRIAL APPLICABILITY

The above-mentioned apparatus, while being described as an apparatus for use in any GTE, can be applied, for example, to rocket-engine turbo-pumps and expendable turbine engines. The foregoing apparatus can also be applied to any arrangement where there is a desire to oppose hot-gas ingress into a space between two bodies that that rotate relative to one another. When there are parallel rotating disks with a hot gas passing by the disks, there is a natural propensity for the hot gas to be pumped into the space between the rotating disks. While purge air can be provided in the space to counter the hot-gas ingress, the above-described apparatus can also be employed.

The GTE 10 produces power by extracting energy from a flow of hot gas produced by combustion of fuel in a stream of compressed fluid, for example air, from the compressor section 20. Energy is released when a mixture of the compressed air and fuel is burned in the combustor section 18 The fuel injection nozzles 34 direct a liquid or gaseous hydrocarbon fuel into the combustor section 18 for combustion. The resulting hot gases are directed through the turbine section 14, over the stator vanes and the turbine blades, to spin the turbine and produce mechanical power.

As noted above, a portion of the compressed fluid, referred to herein as cooling fluid, from the compressor section 20 can be bled from the compressor section 20 and made to flow into the turbine rotor cavities 46, 48, 49. In some instances, the cooling fluid can flow through labyrinth seals (not shown) and into the turbine rotor cavities 46, 48, 49. The flow of cooling fluid can be used to cool and prevent or oppose ingestion of hot gases 57 into the internal components of the GTE. In order to further prevent ingestion of hot gases 57, purging fins 50, 52 and/or guide fins 52, 54 can be provided on the turbine blades and stator vanes, respectively. Thus, the purging fins 50, 52 and/or the guide fins 54, 56 can be combined with the cooling air flow to oppose hot gas ingress into the turbine rotor cavities 46, 48, 49.

The purging fins 50, 52 oppose hot gas ingestion by generating a pumping action during operation of the GTE 10. Specifically, the purging fins 50, 52 create radial outflows in the turbine rotor cavities at specific locations where there is likely to be hot-gas ingress (FIGS. 2 and 9). Referring to the first stage of the turbine section 14, as the rotor 36 rotates adjacent the stator 35, the purging fins 50, 52 (not shown in FIG. 9) generate a forced outflow of air 55 in the turbine rotor cavity 46. In this respect, providing the purging fins 50, 52 causes the turbine section to act as a centrifugal pump, generating an outflow of air 55 to counteract hot combustion gas ingestion 57 into the turbine rotor cavities. While the purging fins 50, 52 generate the outflow 55, the guide fins 54, 56 can also be provided on the stator vanes 39, 45, respectively, to help guide the outflow 55 against hot gas ingress 57.

Referring to FIG. 9, which is a schematic view of the operation of the first stage of the turbine section 14 of FIG. 1, the purging fins 50, 52 (not shown in FIG. 9) can generate the outflow 55 near the leading edges 68 of the turbine blades 43 at locations around a circumference of the stator 35 and rotor 36. FIG. 9 shows a portion of the disk-shaped stator 35 and disk-shaped rotor 36 along with the stator vanes 39 and the turbine blades 43. FIG. 9, as well as FIG. 2, shows the outflow 55 opposing the flow of hot combustion gas 57 into the turbine rotor cavity 46. Although outflow 55 is only shown at one circumferential location in FIG. 9, purging fins 50, 52 can be associated with each turbine blade 43, thereby generating a forced outflows 55 at a plurality of circumferential locations in the turbine rotor cavity 46 between the stator 35 and the rotor 36.

In some instances, the turbine blades 43 and/or stator vanes 39 may be manufactured by a known casting process, for example investment casting. The purging fins 50, 52 may be cast together with the turbine blades 43 so that the purging fins 50, 52 are formed integrally with the turbine blades 43. Thus, the turbine blades 43 can be manufactured so that the purging fins 50, 52 are continuous from the platform 60 and root 64 of the turbine blades 43. Similarly, the guide fins 54, 56 can be cast together with stator vanes 39, for example stator vanes 39 and 45, so that the guide fins 54, 56 are formed integrally with the stator vanes 39, 45. Thus, the stator vanes 39, 45 can be manufactured so that the guide fins 54, 56 are continuous along the stator vane platform 62. In other instances, the guide fins 54, 56 can be manufactured, for example via casting, separately from the stator vanes 39, 45, and attached to the stator vanes 39, 45 at a later time using known fixation techniques such as welding. In some instances, the casting material for the turbine blades and/or stator vanes, and therefore also for the purging fins 50, 52 and guide fins 54, 56, may be metal. The turbine blades 43 and/or stator vanes 39, 45 may also be cast as a single crystal, or monocrystalline solid, and may be made of a superalloy.

In forming the turbine blades 43, the purging fins 50, 52 can be designed to have a shape corresponding to the contours of the turbine blade 43. Thus, the purging fins 50, 52 can be referred to as being “aerodynamically designed” for a given turbine blade. Similarly, the guide fins 54, 56 may be designed to have shapes and dimensions corresponding to the stator vanes 39, 45, as described above with respect to FIGS. 7 and 8. As noted above, the shapes and dimensions of the purging fins 50, 52 and guide fins 54, 56 can depend on the shape of the turbine blade and stator vane, respectively. In some instances, an optimization process can be employed, involving aerodynamic analysis of a given turbine blade and/or stator vane to optimize, for example, the location, number, shape, and dimensions of purging fins 50, 52 and/or guide fins 54, 56. During optimization, the shape and dimensions of the purging fins 50, 52 and/or guide fins 54, 56 can be optimized to achieve a desired pumping effect to generate the outflow 55 in the turbine rotor cavities.

In conventional GTEs, hot gas ingress into disk cavities is a persistent durability issue. Turbine section rotor failures can be attributed to a failure to adequately oppose ingress of hot combustion gasses passing through the turbine section. This hot gas ingress phenomena is a result of periodic pressure variation created by interactions between the rotor and the stator during GTE operation. For example, as shown in FIG. 9, there can be hot gas ingress 57 at or near turbine blade 43 leading edges 68, while there is natural egress 63 of air between blade leading edges 68. While providing cooling air bled-off from the compressor and discouragers on the turbine blades can help oppose hot air ingress, there often remains the risk of premature failure of GTE components due to exposure to hot combustion gases.

In order to mitigate the flow of hot gas into the turbine rotor cavities, blade-shape dependent purging fins and/or guide fins are provided on the turbine blades and stator vanes, respectively. As shown in FIG. 9, the above-described apparatus generates a pumping action to provide forced outflow 55 where hot-gas ingress 57 typically occurs, for example, at the turbine blade leading edges 68. As described with respect to FIGS. 3-6, forming the purging fins 50, 52 to conform to the shape of the turbine blades 43 can help generate this pumping action during operation of the GTE. Similarly, as described with respect to FIGS. 7 and 8, forming guide fins 54, 56 on the stator vanes 39, 45 can help guide the outflow 55 generated by purging fins 50, 52. Any resultant power loss from generating the pumping action, which can be referred to herein as “cyclic penalty,” is manageable with the above-described apparatus and methods, and may be outweighed by the benefits of preventing damaging hot combustion gas from flowing into the turbine rotor cavities.

As noted above, a main portion of the compressed air is typically reserved for engine combustion and providing useful engine power. Thus, it is generally undesirable to increase an amount of cooling air bled off from the compressor to flow into the turbine rotor cavities for opposition or prevention of hot gas ingress. The forced outflow generated by the purging fins described herein and guided by the guide fins may reduce the amount of cooling air that is bled off from the compressor section, while effectively opposing hot gas ingress into the turbine rotor cavities. Thus, the present apparatus and methods may reserve compressed air for generating engine power while preventing degradation of GTE components due to overheating, thereby assisting in improving GTE performance. Opposing hot gas ingress in this manner can enhance the working life of the rotors and stators of the various stages in the turbine section of a GTE.

Although the turbine blade 43 shown in FIGS. 3-6 includes two purging fins, 50 and 52, in other embodiments the turbine blade 43 may include only one purging fin, or more than two purging fins. Additionally, although some of the description provided herein for the turbine cooling apparatus and method refers to the first and/or second stages of the turbine section of a GTE, the apparatus and methods can be applicable to any stage of the turbine section 14. Furthermore, while FIGS. 1 and 2 illustrate the turbine blades 43 having purging fins 50, 52 and the stator vanes 39, 45 having guide fins 56, 54, respectively, in some instances the guide fins 56, 54 are not included in the turbine section 14 of the GTE 10. As described above, the purging fins 50, 52 generate the pumping action to create the outflow 55 to counteract hot gas ingestion into the turbine rotor disk cavities. While the guide fins 54, 56 on the stator vanes help guide the outflow, in some instances, the turbine blades have purging fins 50, 52 to generate the outflow 55 without the stator vanes having any additional guide fins.

It will be apparent to those skilled in the art that various modifications and variations can be made to the disclosed turbine cooling system. Other embodiments will be apparent to those skilled in the art from consideration of the specification and practice of the disclosed system and method. It is intended that the specification and examples be considered as exemplary only, with a true scope being indicated by the following claims and their equivalents.

What is claimed is:

1. A turbine blade for a turbine section of a gas turbine engine, wherein the turbine blade comprises:
an airfoil;
a platform extending from one side of the airfoil;
a root extending from the platform; and
at least one purging fin connected to the root and an underside of the platform, wherein the at least one purging fin extends along a wall of the root

2. The turbine blade of claim 1, wherein the at least one purging fin is integrated with the root and the platform.

3. The turbine blade of claim 1, wherein the at least one purging fin is aligned with one of a leading edge and a trailing edge of the turbine blade.

4. The turbine blade of claim 1, wherein the at least one purging fin extends to a corner of the platform.

5. The turbine blade of claim 1, wherein the at least one purging fin is biased to one side of a centerline of the turbine blade

6. The turbine blade of claim 1, wherein the at least one purging fin comprises a first purging fin and a second purging fin.

7. The turbine blade of claim 6, wherein the first purging fin is disposed proximate a leading edge of the turbine blade, and wherein the second purging fin is disposed proximate a trailing edge of the turbine blade.

8. The turbine blade of claim 6, wherein the first purging fin and the second purging fin are each biased to one side of a centerline of the turbine blade.

9. The turbine blade of claim 6, wherein the first purging fin is aligned with a leading edge of the turbine blade, and wherein the second purging fin is aligned with a trailing edge of the turbine blade.

10. A gas turbine engine comprising:
a compressor section configured to compress a flow of air;
a combustor section configured to combust a mixture of the air and a fuel to produce a hot gas flow; and
a turbine section configured to use the hot gas flow to produce power, wherein the turbine section comprises:
at least one stator;
at least one rotor; and
a turbine rotor cavity disposed between the at least one stator and the at least one rotor, wherein a plurality of stator vanes are connected to the at least one stator, and wherein a plurality of turbine blades are connected to the at least one rotor, wherein each turbine blade of the plurality of turbine blades comprises:
an airfoil;
a platform extending from one side of the airfoil;
a root extending from the platform; and
at least one purging fin connected to the root and an underside of the platform, wherein the at least one purging fin extends along a wall of the root.

11. The gas turbine engine of claim 10, wherein a plurality of stator vanes are connected to the at least one stator, wherein each stator vane of the plurality of stator vanes comprises:
an airfoil;
a platform extending from one side of the airfoil; and
at least one guide fin connected to one of an upper-side of the platform or an underside of the platform.

12. The gas turbine engine of claim 11, wherein the at least one guide fin is connected to the upper-side of the platform and extends between a leading edge of the stator vane and an upstream edge of the stator vane platform.

13. The gas turbine engine of claim 11, wherein the at least one guide fin is connected to the underside of the platform and extends between a trailing edge of the stator vane and a downstream edge of the stator vane platform.

14. The gas turbine engine of claim 11, wherein the at least one guide fin comprises a first guide fin an a second guide fin, wherein the first guide fin is connected to the upper-side of the platform and extends between a leading edge of the stator vane and an upstream edge of the stator vane platform, and wherein the second guide fin is connected to the underside of the platform and extends between a trailing edge of the stator vane and a downstream edge of the stator vane platform.

15. The gas turbine engine of claim 10, wherein the at least one purging fin is aligned with one of a leading edge or a trailing edge of the turbine blade.

16. The gas turbine engine of claim 10, wherein the at least one purging fin comprises a first purging fin and a second purging fin.

17. The turbine blade of claim 16, wherein the first purging fin is disposed proximate a leading edge of the turbine blade, and wherein the second purging fin is disposed proximate a trailing edge of the turbine blade.

18. A method of cooling components of a gas turbine engine, comprising:
generating a pumping action in a turbine section of the gas turbine engine, wherein the pumping action produces an outflow that opposes ingress of combustion gases into a turbine rotor cavity of the turbine section.

19. The method of claim 18, wherein the pumping action is a centrifugal pumping action.

20. The method of claim 18, further comprising guiding the outflow via guide fins, wherein the guide fins are provided on a stator portion within the turbine section.
